(19) United States
(12) Patent Application Publication
(10) Pub. No.: US 2019/0371038 A1
(43) Pub. Date: Dec. 5, 2019

(54) SYSTEM AND METHOD FOR CREATING ANIMATED GREETING CARDS

(71) Applicants: Guennadi Filkov, Richmond (CA); Oleg Filkov, Moscow (RU); Olga Roberts, Richmond (CA)

(72) Inventors: Guennadi Filkov, Richmond (CA); Oleg Filkov, Moscow (RU); Olga Roberts, Richmond (CA)

(21) Appl. No.: 15/997,605

(22) Filed: Jun. 4, 2018

(51) Int. Cl. G06T 13/80; G06F 17/30; G06F 3/0484; G06F 3/0481

(52) U.S. Cl. CPC G06T 13/80; G06F 3/04817; G06F 3/04842; G06F 17/30271

(57) ABSTRACT

A computer-implemented method and system for creating animated greeting cards comprising providing a user interface operable to receive an inputted greeting text, selecting at least one graphical object from a plurality of graphical objects stored within a database, utilizing a processing circuit to generate a digital animation of a plurality of the at least one graphical object to form an animated image of the greeting text, and displaying the animated image of the greeting text. The system comprises a user interface, CPU, network connection, display and database.

### BACKGROUND OF THE INVENTION

### 1. Field of Invention

The present invention relates generally to digital greeting cards and in particular to a system and method for creating animated digital greeting cards.

2. Description of Related Art

Electronic greeting cards (eCards) are a popular means to communicate with others via the Internet. Many eCards include digital animation to increase their attractiveness. Personal messages may also be included in an eCard to address a specific recipient by name or to include any other personalized message. Existing electronic greeting card systems are not built dynamically from animation objects and may therefore be less visually appealing.

### SUMMARY OF THE INVENTION

According to a first embodiment of the present invention there is disclosed a computer-implemented method for creating animated greeting cards. The method comprises providing a user interface operable to receive an inputted greeting text, selecting at least one graphical object from a plurality of graphical objects stored within a database, utilizing a processing circuit to generate a digital animation of a plurality of the at least one graphical object to form an animated image of the greeting text, and displaying the animated image of the greeting text.

The user interface may be configured to connect with the processing circuit through a network.

The at least one graphical object may be selected through the user interface. The plurality of graphical objects may be categorized into at least one of a plurality of themes. The at least one graphical object may be presented using a mode selected from a group consisting of raster and vector graphics.

The digital animation may include an initial greeting card display wherein at least one of the plurality of the at least one graphical object is displayed at a static first position not forming the animated image of the greeting text. The digital animation may include a final greeting card display wherein the plurality of the at least one graphical object is displayed at an animated final position forming the animated image of the greeting text. The plurality of the at least one graphical object may be animated to move between the static first position and the animated final position.

The method may further comprise receiving an inputted greeting card recipient. The digital animation may be transmitted to the greeting card recipient through a network.

The greeting text may comprise at least one of a plurality of characters. Each of the plurality of characters may be defined by a character boundary. The at least one graphical object may include a reference point. The processing circuit may be operable to position each of the at least one graphical object such that each reference point is located randomly within the character boundaries to form the animated image of the greeting text. The processing circuit may be operable to randomly size the each of the at least one graphical object within a defined size range.

The animated greeting card may include at least one of a plurality of digital assets selected from a group consisting of background images, overlay images, image sprites, video clips, sound clips, and sound sprites.

According to a further embodiment of the present invention there is disclosed a computer-implemented system for creating animated greeting cards comprising a user interface, a CPU, a network connection and a display. The system further comprises a database storing a plurality of graphical objects wherein the user interface is in communication with the CPU and the CPU is configured to access the database. The user interface is configured to receive an inputted greeting text and the user interface is configured to receive a selection of at least one of the plurality of graphical objects. The CPU is configured to generate a digital animation of a plurality of the at least one of the plurality of graphical objects to form an animated image of the greeting text and the CPU is configured to cause the animated image of the greeting text to be displayed to a user on the display.

The system may further comprise a network connection. The user interface may be in communication with the CPU through the network connection. The display may be in communication with the CPU through the network connection.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is an illustration of a computer-implement system for creating animated greeting cards according to a first embodiment of the present invention.

FIG. 2 is a block diagram of the CPU of the system of FIG. 1.

FIG. 3 is a flowchart of computer steps for creating an animated greeting card using the system of FIG. 1.

FIG. 4 is a flowchart of computer steps for generating a digital animation for use in creating an animated greeting card using the system of FIG. 1

FIG. 5 is a screenshot of an initial greeting card display.

FIG. 6 is a sample greeting text.

FIG. 7 is a screenshot of a final greeting card display.

FIG. 8 is a screenshot of a greeting card display.

### DETAILED DESCRIPTION

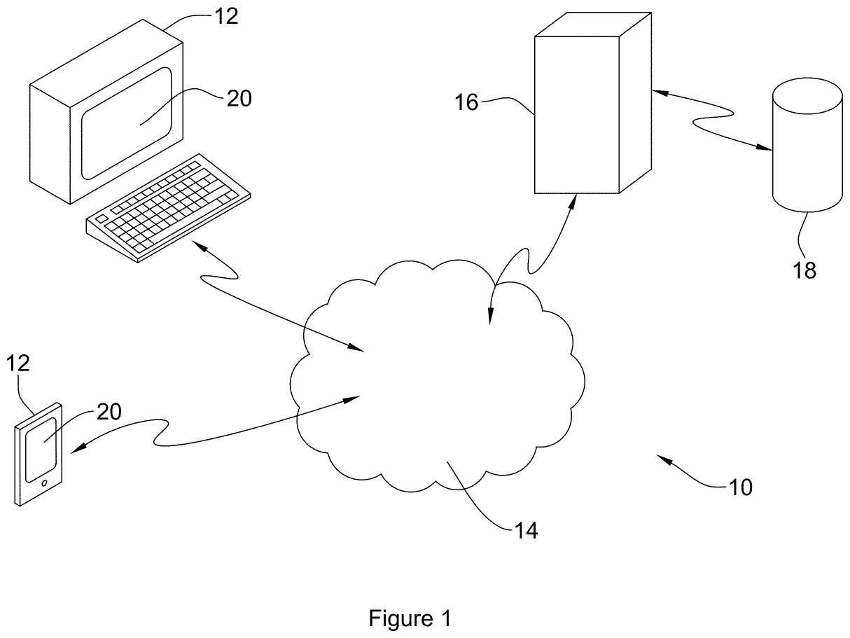

Referring to FIG. 1, a system for creating animated greeting cards according to a first embodiment of the invention is shown generally at 10. The system 10 comprises at least one user device 12, a network 14 and a system server or CPU 16 connected to at least one database 18. The database 18 contains a plurality of graphical objects, as will be further set out below. The network 14 is operable to transmit communications between each user device 12 and the CPU 16. It will be appreciated that each user device 12 includes a display 20 and may be any commonly known user device, such as, by way of non-limiting example, a tablet, laptop computer, smartphone, PDA, ultra-mobile PC (UMPC), desktop computer, server, etc. It will be understood that the architecture herein is provided for example purposes only and does not limit the scope of the various implementations of the communications systems and methods. As will be further described below, the user device 12 is adapted to receive an inputted greeting text and to receive a graphical object selection from the plurality of graphical objects contained within the database 18 and to display an animated greeting card image on the display 20.

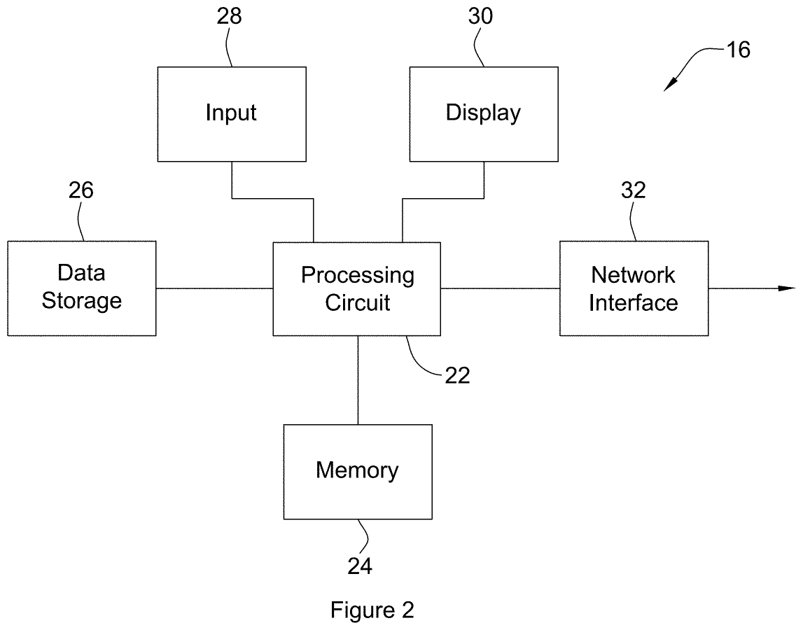

Turning now to FIG. 2, the CPU 16 comprises a processing circuit 22, and memory 24 that stores machine instructions that, when executed by the processing circuit 22, cause the processing circuit 22 to perform one or more of the operations and methods described herein. The processing circuit 22 may optionally contain a cache memory unit for temporary local storage of instructions, data, or computer addresses. The CPU 16 further includes a data storage 26 of any conventional type operable to store information such as an inputted greeting text and may optionally include an input 28 and display 30 for receiving and displaying inputs from a database manager or user. As illustrated in FIG. 2, the CPU 16 also includes a network interface 32 such as a radio transmitter, ethernet adapter or the like for providing communication between the processing circuit 22 and the database 18 and/or user devices 12 as illustrated in FIG. 1.

More generally, in this specification, including the claims, the term “processing circuit ” is intended to broadly encompass any type of device or combination of devices capable of performing the functions described herein, including (without limitation) other types of microprocessing circuits, microcontrollers, other integrated circuits, other types of circuits or combinations of circuits, logic gates or gate arrays, or programmable devices of any sort, for example, either alone or in combination with other such devices located at the same location or remotely from each other. Additional types of processing circuit(s) will be apparent to those ordinarily skilled in the art upon review of this specification, and substitution of any such other types of processing circuit(s) is considered not to depart from the scope of the present invention as defined by the claims appended hereto. In various embodiments, the processing circuit 22 can be implemented as a single-chip, multiple chips and/or other electrical components including one or more integrated circuits and printed circuit boards.

Computer code comprising instructions for the processing circuit(s) to carry out the various embodiments, aspects, features, etc. of the present disclosure may reside in the memory 24. The code may be broken into separate routines, products, etc. to carry forth specific steps disclosed herein. In various embodiments, the processing circuit 22 can be implemented as a single-chip, multiple chips and/or other electrical components including one or more integrated circuits and printed circuit boards. The processing circuit 22 together with a suitable operating system may operate to execute instructions in the form of computer code and produce and use data. By way of example and not by way of limitation, the operating system may be Windows-based, Mac-based, or Unix or Linux-based, among other suitable operating systems. Operating systems are generally well known and will not be described in further detail here.

Memory 24 may include various tangible, non-transitory computer-readable media including Read-Only Memory (ROM) and/or Random-Access Memory (RAM). As is well known in the art, ROM acts to transfer data and instructions uni-directionally to the processing circuit 22, and RAM is used typically to transfer data and instructions in a bi-directional manner. In the various embodiments disclosed herein, RAM includes computer program instructions that when executed by the processing circuit 22 cause the processing circuit 22 to execute the program instructions described in greater detail below. More generally, the term “memory” as used herein encompasses one or more storage mediums and generally provides a place to store computer code (e.g., software and/or firmware) and data that are used by the user device 12. It may comprise, for example, electronic, optical, magnetic, or any other storage or transmission device capable of providing the processing circuit 22 with program instructions. Memory 24 may further include a floppy disk, CD-ROM, DVD, magnetic disk, memory chip, ASIC, FPGA, EEPROM, EPROM, flash memory, optical media, or any other suitable memory from which processing circuit 22 can read instructions in computer programming languages.

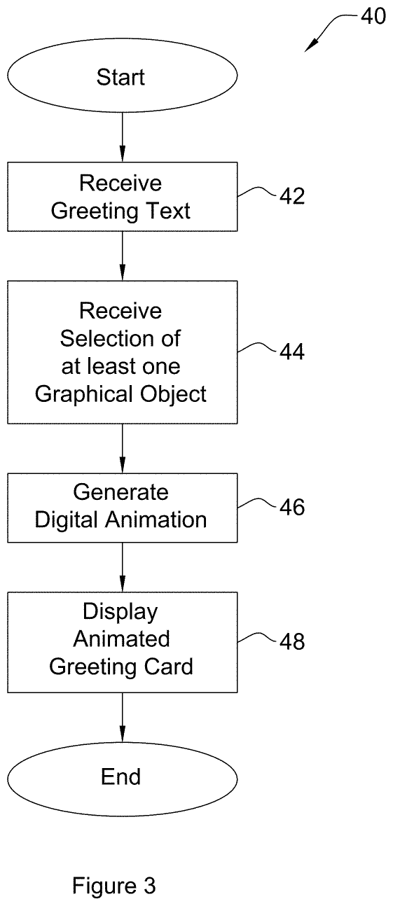

As set out above, the CPU 16 is configured to receive an inputted greeting text and a graphical object selection from the user device 12 and to generate an animated greeting image for presentation on the display 20. In particular, as illustrated in FIG. 3, a method of receiving inputs for use in the above system and producing an animated greeting card is illustrated generally at 40. The method comprises receiving an inputted greeting text from a user at step 42. The greeting text is comprised of a series of characters, as are commonly known. The user is presented with a selection of graphical objects from the database 18 on the user interface display 20. The graphical objects may be filtered by a theme, such as, by way of non-limiting example, seasons, weather, upcoming public events, birthdays, Olympic games, sports teams, etc. Each theme may contain a plurality of graphical objects, such as, by way of non-limiting example, a spring season theme may include a variety of flowers, birds, bees, butterflies, baby animals, etc. The graphical objects may be such as, by way of non-limiting example, raster or vector images, as is commonly known in the art. The system receives the user selection of at least one graphical object at step 44. It will be appreciated that the method of permitting a user to select such a graphical object may be by any conventional means, such as, by way of non-limiting example, pull-down menu or checkboxes displayed to the user on the user interface display 20. As will be set out in further detail below, the system generates a digital animation of a plurality of the at least one graphical object to form an animated image of the greeting text at step 46. Once generated, the system displays a complete animated greeting card at step 48. It will be appreciated that the aminated greeting card includes the animated image of the greeting text generated at step 46. Optionally, the animated greeting card may include such as, by way of non-limiting example, a personal message added by the user or suggested by the system, a background image, overlay images, image sprites, video clips, sound clips and/or sound sprites, as is commonly known in the art.

It will be appreciated that the user may input or select a greeting card recipient either before or after the creation of the animated greeting card. The recipient may be selected from such as, by way of non-limiting example, a list of social media contacts or a recipient e-mail address may be supplied by the user. The animated greeting card may be delivered to the recipient's user device 12 through the network 14 as such as, by way of non-limiting example, an e-mail containing an Internet link to the animated greeting card, an e-mail containing the embedded animated greeting card, or through a social media post, as is commonly known.

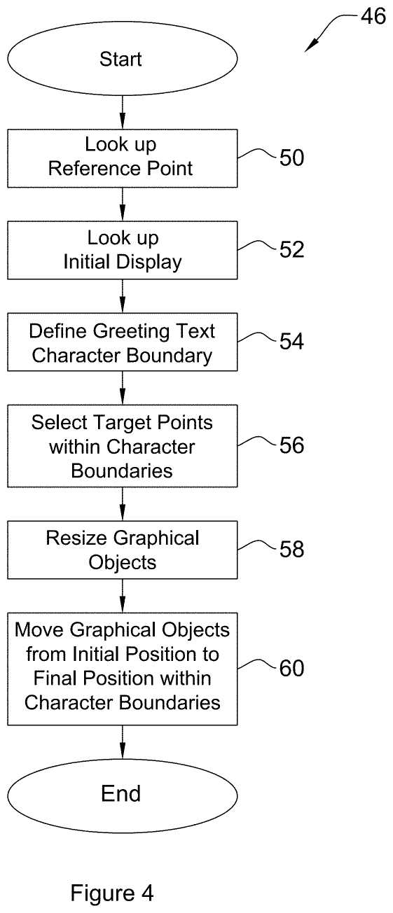

Turning now to FIG. 4, the method to generate a digital animation as illustrated at step 46 is presented in further detail. Each graphical object includes a reference point used to position the graphical object within the boundaries of a display, as is commonly known. The reference point may be located at any point relative to the graphical object, such as, by way of non-limiting example, on its border or in the middle of the graphical object. The reference point for the selected graphical objects is determined in step 50 and stored for later use, as will be set out below.

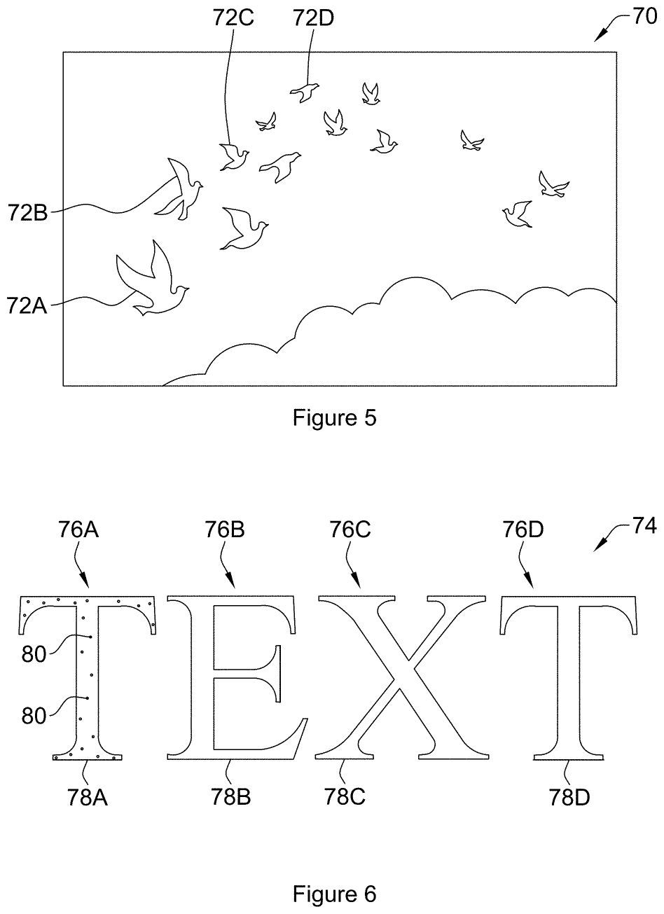

Each graphical object has an associated initial greeting card display image. The system looks up the initial display at step 52. It will be appreciated that the data for the initial greeting card display may be stored in one of the databases 18. FIG. 5 illustrates a sample screenshot of an initial greeting card display 70. In this example, the graphical object 72 is a bird, with a plurality of bird graphical objects 72A-72D displayed on the initial greeting card display 70 at a variety of sizes, rotations and positions. Although four different bird graphical objects 72A-72D are illustrated in this sample, it will be appreciated that more or less variations on the graphical object 72 may be used for each greeting card. It will also be appreciated that the initial greeting card display 70 may not include a graphical object 72, such that the initial position of the graphical object 72 is “off screen” and not initially viewable.

As set out above, the greeting text is comprised of at least one character. Each character is defined by a character boundary. When a plurality of characters are joined together to form a greeting text, a set of character boundaries is defined. At step 54 the system defines the greeting text character boundary, which may include one or more characters joined together to form a word or message. FIG. 6 illustrates a sample greeting text 74 with characters 76A-76D defining character boundaries 78A-78D. Although the greeting text characters 76 are represented as letters in this example, it will be appreciated that characters may be letters, numbers or symbols, as is commonly known.

With the character boundary 78 defined, a plurality of target points 80 within the character boundary 78 is selected at step 56 of FIG. 4. The target points are selected following a set of pre-defined parameters which may include such as, by way of non-limiting example, minimum and maximum distance between the target points and distance from the character boundary 78. The target points 80 may be spaced apart at a set distance, may be on a grid, or may be at other defined locations. FIG. 6 illustrates an example of target points 80 within the character boundary 78A. It will be appreciated that target points 80 are selected within all character boundaries 78.

To fit a plurality of the graphical object 72 within the character boundary 78, the graphical object 72 is resized (scaled) at step 58 of FIG. 4. With a plurality of related graphical objects 72, as illustrated at 72A-72D in FIG. 5, graphical objects 72 are randomly selected for placement at the target points 80 and may be sized to fit within the character boundaries 78. The graphical objects 72 may be rotated and mirrored in addition to being scaled to an appropriate size. The graphical objects 72 are placed within the character boundary 78 such that the reference points from step 50 are positioned relative to the target points 80. The graphical objects 72 may be sized and placed such that they do not overlap other graphical objects 72 with space therebetween, or they may be sized and placed to intentionally overlap, depending on the design of the graphical object 72. Such as, by way of non-limiting example, a plurality of birds may not overlap, but a plurality of flowers may be intentionally overlapped within the character boundaries 78. In addition, the graphical objects 72 may be sized to extend over the character boundaries 78 by a set allowable distance. As will be set out below, in some cases the graphical objects 72 may initially be located such that they fall within the character boundaries 78. In such cases, the graphical objects 72 will be removed from the target points 80. Examples follow below.

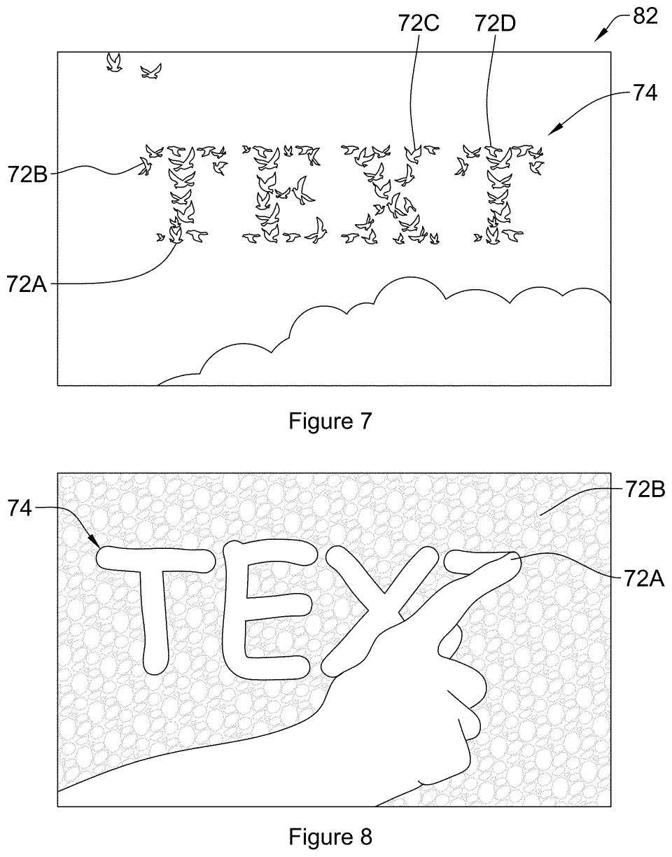

A plurality of graphical objects 72 are moved and scaled from their position within the initial greeting card display 70, as illustrated in FIG. 5, to a final position within the character boundaries 78 of the greeting text 74 on the final greeting card display 82, as illustrated in FIG. 7, at step 60 of FIG. 4. The plurality of graphical objects 72 may be moved from their individual locations within the initial greeting card display 70, with additional graphical objects 72 introduced from outside of the image. It will be appreciated that in some cases the graphical objects 72 may not appear in the initial greeting card display 70 with all graphical objects introduced to the display at step 60. The plurality of graphical objects 72 may be animated, as is commonly known, between the initial and final positions, such as, by way of non-limiting example, birds may “flap” their wings as though they are flying, or flower petals may flutter as though they are falling or being blown through the air. It will be appreciated that the nature of the animation will depend on the image represented by the graphical object 72.

Turning now to FIG. 8, an alternate method of creating the greeting card display is illustrated. In this method, the greeting text 74 is also formed using a plurality of graphical objects 72. In the illustrated example, a hand with an extended finger graphical object 72A is animated to move across a pane of glass with a plurality of water droplet graphical objects 72B thereon. As the hand with an extended finger graphical object 72A progresses across the greeting card display, the water droplet graphical objects 72B are removed from the target points 80 following the path of the hand with an extended finger graphical object 72A, creating the greeting text 74. It will be appreciated that other graphical objects 72 may be used, as well, such as, by way of non-limiting example, an airplane flying across the greeting card display leaving clouds of exhaust behind at the target points 80 to create the greeting text, an icing bag squeezed across the top of a cake to create the greeting text or feet walking across wet sand to create the greeting text.

It will be appreciated that the both the initial and final greeting card displays, 70 and 82, respectively, may include additional digital assets, such as, by way of non-limiting example, background images, overlay images, image sprites, video clips, sound clips, and sound sprites, as is commonly known in the art. There may also be an option for the user to insert an additional static message (not animated) to the image as a means to further personalize the greeting card.

While specific embodiments of the invention have been described and illustrated, such embodiments should be considered illustrative of the invention only and not as limiting the invention as construed in accordance with the accompanying claims.

What is claimed is:

1. A computer-implemented method for creating animated greeting cards comprising:
providing a user interface operable to receive an inputted greeting text;
selecting at least one graphical object from a plurality of graphical objects stored within a database;
utilizing a processing circuit to generate a digital animation of a plurality of said at least one graphical object to form an animated image of said greeting text; and
displaying said animated image of said greeting text.

2. The method of claim 1 wherein said user interface is configured to connect with said processing circuit through a network.

3. The method of claim 1 wherein said at least one graphical object is selected through said user interface.

4. The method of claim 1 wherein said plurality of graphical objects are categorized into at least one of a plurality of themes wherein selecting at least one of said plurality of themes selects at least one of said plurality of graphical objects associated with said at least one of said plurality of themes.

5. The method of claim 1 wherein said at least one graphical object is presented using a mode selected from a group consisting of raster and vector graphics.

6. The method of claim 1 wherein said digital animation includes an initial greeting card display wherein said plurality of said at least one graphical object do not form said animated image of said greeting text.

7. The method of claim 6 wherein said digital animation includes a final greeting card display wherein said plurality of said at least one graphical object is displayed at an animated final position forming said animated image of said greeting text.

8. The method of claim 7 wherein said plurality of said at least one graphical object is animated to move to said animated final position.

9. The method of claim 1 further comprising receiving an inputted greeting card recipient.

10. The method of claim 9 wherein said digital animation is transmitted to said greeting card recipient through a network.

11. The method of claim 1 wherein said greeting text is comprised of at least one of a plurality of characters.

12. The method of claim 11 wherein each of said plurality of characters is defined by a character boundary.

13. The method of claim 12 wherein each of said at least one graphical object includes a reference point.

14. The method of claim 13 wherein said processing circuit is operable to position said each of said at least one graphical object such that each said reference point is located within said character boundaries to form said animated image of said greeting text.

15. The method of claim 14 wherein said processing circuit is operable to randomly size said each of said at least one graphical object within a defined size range.

16. The method of claim 1 wherein the animated greeting card includes at least one of a plurality of digital assets selected from a group consisting of background images, overlay images, image sprites, video clips, sound clips, and sound sprites.

17. A computer-implemented system for creating animated greeting cards comprising:
a user interface;
a CPU;
a network connection;
a display;
a database storing a plurality of graphical objects;
wherein said user interface is in communication with said CPU;
wherein said CPU is configured to access said database;
wherein said user interface is configured to receive an inputted greeting text;
wherein said user interface is configured to receive a selection of at least one of said plurality of graphical objects;
wherein said CPU is configured to generate a digital animation of a plurality of said at least one of said plurality of graphical objects to form an animated image of said greeting text; and
wherein said CPU is configured to cause said animated image of said greeting text to be displayed to a user on said display.

18. The system of claim 17 further comprising a network connection.

19. The system of claim 18 wherein said user interface is in communication with said CPU through said network connection.

20. The system of claim 18 wherein said display is in communication with said CPU through said network connection.
